(19) United States
(12) Patent Application Publication
(10) Pub. No.: US 2011/0067539 A1
(43) Pub. Date: Mar. 24, 2011

(54) FILM POSITIONER

(75) Inventor: Arkadiy Turchin, Berlin, CT (US)

(73) Assignee: STANDARD KNAPP INC., Portland, CT (US)

(21) Appl. No.: 12/566,246

(22) Filed: Sep. 24, 2009

(51) Int. Cl. B26D 7/06; B65H 23/02

(52) U.S. Cl. 83/448; 226/196.1; 226/1

(57) ABSTRACT

A film positioner includes at least one film guide having a plurality of parallel guide bars. The guide bars are operably receptive to at least one film material strip and extend at least partially across the film positioner with axes nonparallel to a lateral extent of the film positioner. A method of changing a lateral position of at least one film material strip includes wrapping the at least one film material strip is around a first guide bar of the plurality of guide bars, thereby turning the at least one material strip to a guide angle from the flow direction. The at least one material strip is wrapped around a second guide bar of the plurality of guide bars, thereby turning the at least one material strip from the turn angle back to the flow direction at a second lateral position different from the first lateral position.

### BACKGROUND

The subject matter disclosed herein generally relates to packaging machines. More specifically, the subject invention relates to conveyance of film wrapping material for packaging machines.

Packaging machines typically convey a product or group of products along a pathway, for example, a conveyor. A piece of wrapping material is typically located on the pathway underneath the product. The film material typically is fed to the packaging machine via a series of rollers. It is often desired to cut the wrapping material sheet into strips and convey the strips to different locations, for example, parallel packaging machines separated by some distance. Separating the strips and achieving the desired distance between them, while maintaining parallel flow of the strips often results in wrinkled and/or torn wrapping material. The art would well receive an apparatus which separates parallel discrete strips of film wrapping material a desired distance apart, while reducing the occurrence of wrinkling, tearing and/or other handling problems.

### SUMMARY

Disclosed herein is a film positioner. The film positioner includes at least one film guide having a plurality of parallel guide bars. The guide bars are operably receptive to at least one film material strip and extend at least partially across the film positioner with axes nonparallel to a lateral extent of the film positioner.

Further disclosed is a method of changing a lateral position of at least one film material strip including urging the at least one film material strip disposed in a first lateral position into a film positioner in a flow direction toward at least one film guide. The at least one film guide includes a plurality of guide bars disposed in parallel. The at least one film material strip is wrapped around a first guide bar of the plurality of guide bars having axes different than the flow direction, thereby turning the at least one material strip to a guide angle from the flow direction. The at least one material strip is wrapped around a second guide bar of the plurality of guide bars, thereby turning the at least one material strip from the turn angle back to the flow direction at a second lateral position different from the first lateral position.

Further disclosed is a film positioner including at least one film guide. The at least one film guide has a plurality of parallel guide bars with axes different than a flow direction of at least one film material strip through the film spreader. The wrapping of the at least one material strip around each of a first guide bar and second guide bar changes a lateral position of the at least one film material strip.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of an embodiment of a film positioner;

FIG. 2 is a plan view of an embodiment of a film positioner;

FIG. 3 is a cross-sectional view of a portion of an embodiment of a film positioner; and

FIG. 4 is a cross-sectional view of a portion of another embodiment of a film positioner.

The detailed description explains embodiments of the invention, together with advantages and features, by way of example with reference to the drawings.

### DETAILED DESCRIPTION OF THE INVENTION

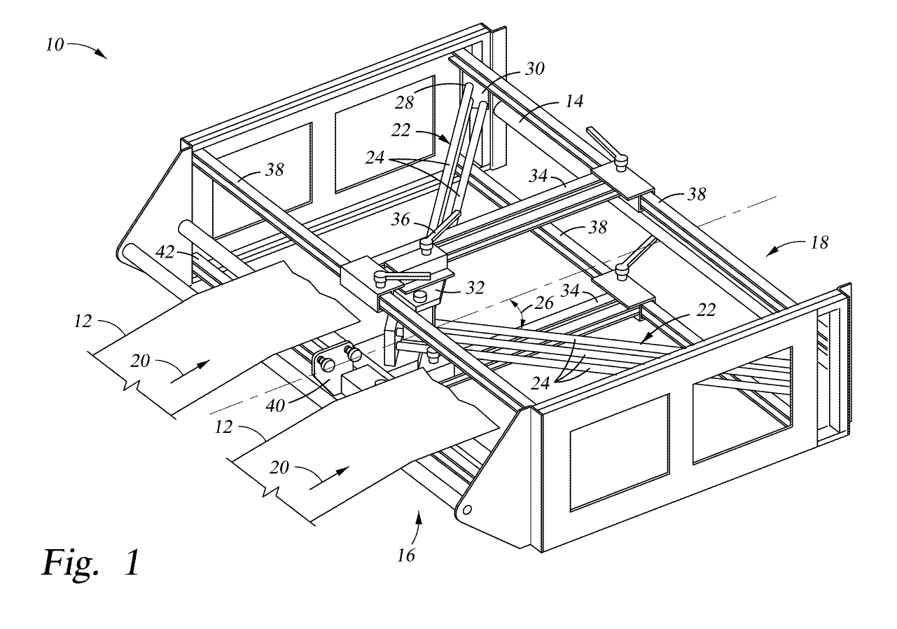

Shown in FIG. 1 is an embodiment of a film positioner 10 for, for example, a packaging machine. The film positioner 10 conveys one or more strips 12 of, for example, film material in the packaging machine. The film positioner 10, in one embodiment, includes a roller 14 located at an infeed end 16 and/or outfeed end 18 of the film positioner 10 to roughly guide the strips 12 through the film positioner 10. The roller 14 is, in one embodiment, disposed across the film positioner 10 substantially perpendicular to a flow direction 20 of the strips 12 entering the film positioner 10.

It is often desired to shift a position of the strips 12 laterally while maintaining an overall flow direction 20. To accomplish this, at least one film guide 22 is located at the film positioner 10 and includes at least two guide bars 24 disposed across the flow direction 20 at a guide angle 26 to the flow direction 20. The embodiment of FIG. 1 includes two strips 12 and film guides 22, but it is to be appreciated that other numbers of film guides 22 to accommodate other numbers of strips 12, for example, three or four film guides 22, may be utilized. In some embodiments, the at least two guide bars 24 are fixed parallel to each other. Each film guide 22 is secured to a frame of the film positioner 10, and may be configured so that the guide angle 26 is adjustable. For example, a pivot end 28 of each film guide 22 may be secured at a guide pivot 30. The film guide 22 is pivotable about the guide pivot 30 to change the guide angle 26. A locking end 32 of each film guide 22 is, in embodiments so equipped, engageable at an adjustment rail 34 of the film positioner 10 which, in some embodiments, extends along the flow direction 20. The locking end 32 is positionable along a length of the adjustment rail 34 and is securable at positions along the adjustment rail 34 via, for example, a clamp mechanism 36 or a pin-and-hole arrangement. Other securing means, however, are contemplated within the scope of the present disclosure. Further, in some embodiments, the position of the adjustment rail 34 may be changed. As shown in FIG. 1, the adjustment rail 34 is positioned approximately at a center of the film positioner 10. When desired, for example, to accommodate strips 12 of different widths, the adjustment rail 34 may be moved from side to side in the film positioner 10 along a lateral rail 38. The adjustment rail 34 may be secured in a desired position along the lateral rail 38 via the clamp mechanism 36 or other means.

To increase the usable width of the film positioner 10 and increase adjustability of the film guides 22, the two film guides 22 are each secured to a different adjustment rail 34. A first adjustment rail 34 is secured to an upper portion of the film positioner 10, and a second adjustment rail 34 is secured to a lower portion of the film positioner 10. This allows for adjustment of the film guides 22 independently of one another and prevents interference between the positions of the film guides 22. In some embodiments, a cutter 40 is located at an infeed end 16 of the film positioner 10. In such embodiments, a single film strip 12 entering the film positioner 10 is cut into two film strips 12 by the cutter 40. While one cutter 40 is shown in FIG. 1, it is to be appreciated that other quantities of cutters 40 may be utilized. Further, the position of the cutter 40 may be adjustable along a cutter bar 42 to produce strips 12 of various desired width.

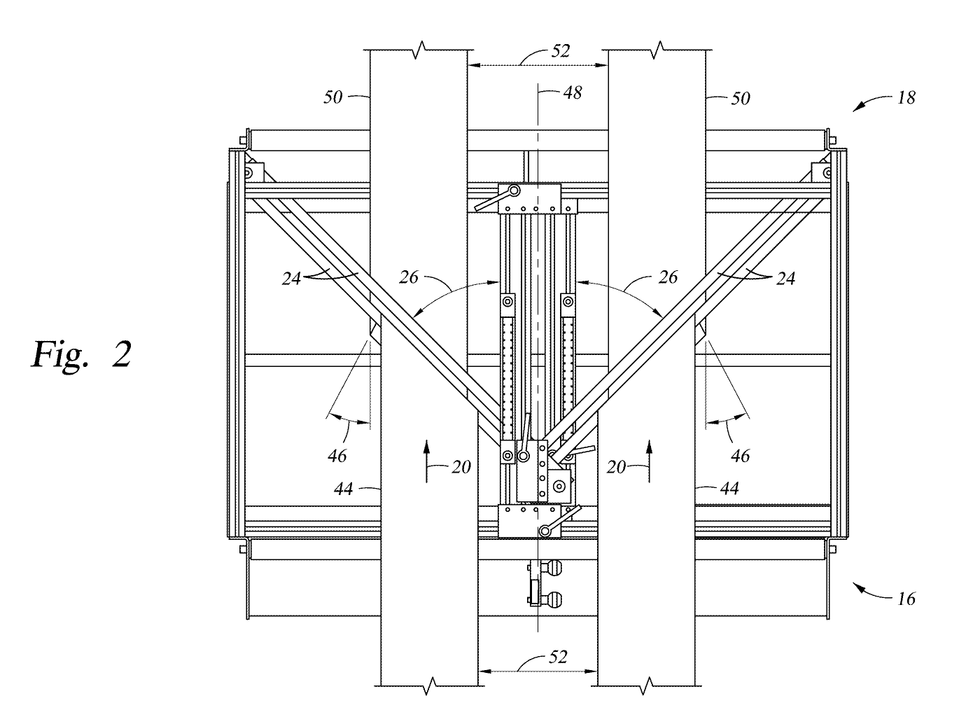

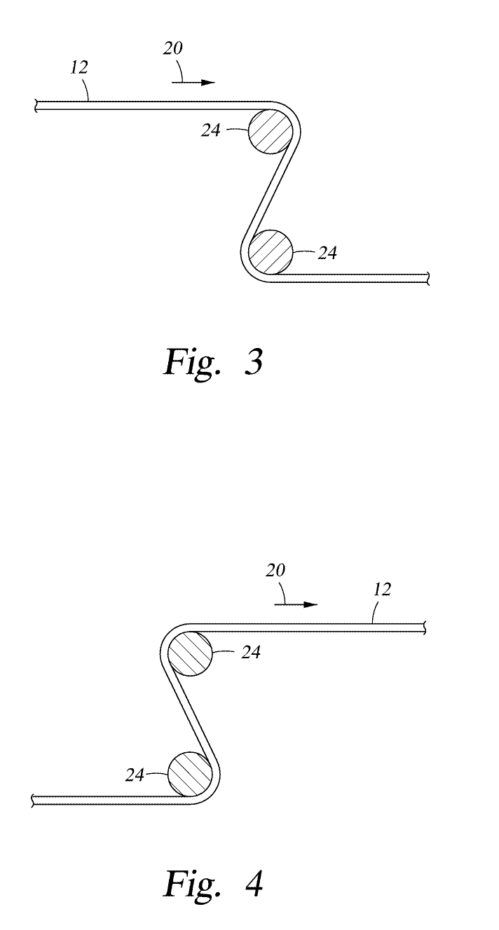

Referring now to FIGS. 2 and 3, two film strips 12 enter the film positioner 10 at the infeed end 16. The film strips 12 flow parallel to each other along the flow direction 20, at a first lateral position 44 in the film positioner 10. The film strip 12 flows over a first guide bar 24 of the two guide bars 24. Since the guide bar 24 is at a guide angle 26 to the flow direction 20, the film strip 12 turns to a turn angle 46, which in some embodiments is substantially complementary to the guide angle 26, where a sum of the turn angle 46 and the guide angle equal ninety degrees. The larger the guide angle 26, the smaller the turn angle 46. The direction of turning the film strip 12 in this embodiment is generally away from a centerline 48 of the film positioner 10. The film strip 12 then flows under a second guide bar 24 of the two guide bars 24. In the embodiment shown, the first guide bar 24 is positioned above the second guide bar 24, but a reversal of this, with the second guide bar 24 above the first guide bar 24, as well as other relative positioning of the guide bars 24 is contemplated within the present scope. Flowing under the second guide bar 24, since it is parallel to the first guide bar 24 of the film guide 22, turns the film strip 12 again so that the film strip 12 flows in the flow direction 20 after passing under the second guide bar 24. The film strip 12 is now at a second lateral position 50, different from the first lateral position 44 but flowing along the flow direction 20. In embodiments where two or more film strips 12 flow over two or more film guides 22, the film guides 22 may be positioned to increase or decrease a lateral distance between the two or more film strips 12. For example, in embodiments where the film strips 12 are turned away from the centerline 48 by the first guide bar 24, a distance 52 between the film strips 12 is increased relative to the distance 52 between the film strips 12 at the infeed end 16. Alternatively, the film guides 22 may be positioned to turn the film strips toward the centerline 48 thus decreasing the distance 52 between the film strips. Further, in some embodiments, the film guides may be configured to turn one film strip 12 toward the centerline 48 and another film strip away from the centerline 48 to laterally shift the film strips 12 while maintaining the distance 52 as constant.

Referring now to FIG. 4, in some embodiments, the film positioner 10 may be configured such that the film strip 12 flows under the first guide bar 24 which turns the film strip 12 the desired turn angle 46. The film strip 12 then flows over the second guide bar 24 to return to the flow direction 20. Further, in some embodiments, if additional lateral movement of the film strips 12 is desired, the film strips 12 may be flowed under and over additional guide bars 24 installed at each film guide 22.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A film positioner comprising at least one film guide including a plurality of parallel guide bars, operably receptive to at least one film material strip and extending at least partially across the film positioner and having axes nonparallel to a lateral extent of the film positioner.

2. The film positioner of claim 1 wherein wrapping at least one material strip around each of a first guide bar and a second guide bar of the plurality of guide bars changes a lateral position of the at least one film material strip

3. The film positioner of claim 1 wherein the at least one film guide is two film guides.

4. The film positioner of claim 3 wherein the two film guides are capable of changing a lateral distance between two material film strips.

5. The film positioner of claim 1 wherein the plurality of guide bars is two guide bars.

6. The film positioner of claim 1 wherein the at least one film guide is moveable to adjust a direction of the axes of the plurality of guide bars.

7. The film positioner of claim 1 wherein the at least one film guide is pivotably secured to an adjustment rail.

8. The film positioner of claim 1 wherein each film guide of the at least one film guide is pivotably secured to a separate adjustment rail.

9. The film positioner of claim 1 comprising at least one cutter to divide the at least one film strip entering the film positioner.

10. A method of changing a lateral position of at least one film material strip comprising:
urging the at least one film material strip disposed in a first lateral position into a film positioner in a flow direction toward at least one film guide including a plurality of guide bars disposed in parallel;
wrapping the at least one film material strip around a first guide bar of the plurality of guide bars having axes different than the flow direction, thereby turning the at least one material strip to a guide angle from the flow direction; and
wrapping the at least one material strip around a second guide bar of the plurality of guide bars, thereby turning the at least one material strip from the turn angle back to the flow direction at a second lateral position different from the first lateral position.

11. The method of claim 10 comprising flowing each of two film material strips through at least one film guide to change a lateral distance between the two film material strips.

12. The method of claim 11 wherein the lateral distance between the two film material strips is increased.

13. The method of claim 11 wherein the lateral distance between the two film strips is decreased.

14. The method of claim 10 comprising separating the at least one film material strip into at least two film material strips and flowing the at least two film material strips in the flow direction toward the at least one film guide.

15. The method of claim 14 comprising separating the at least one film material strip via at least one cutter disposed at an infeed portion of the film positioner.

16. The method of claim 10 comprising turning the film material to a turn angle which is substantially complimentary to the guide angle.

17. The method of claim 10 comprising adjusting a position of the at least one film guide to achieve a desired guide angle.

18. The method of claim 17 wherein the adjusting is by rotating the at least one film guide at an adjustment rail.

19. A film positioner comprising at least one film guide including a plurality of parallel guide bars having axes different than a flow direction of at least one film material strip through the film spreader such that wrapping the at least one material strip around each of a first guide bar and second guide bar changes a lateral position of the at least one film material strip.
